(19) United States
(12) Patent Application Publication
(10) Pub. No.: US 2016/0347598 A1
(43) Pub. Date: Dec. 1, 2016

(54) BEVERAGE COOLER

(71) Applicants: MARK KEVIN GANNON, Fort Worth, TX (US); IVAN HERNANDO ROS, Barcelona (ES)

(72) Inventors: MARK KEVIN GANNON, Fort Worth, TX (US); IVAN HERNANDO ROS, Barcelona (ES)

(21) Appl. No.: 14/721,104

(22) Filed: May 26, 2015

(51) Int. Cl. B67D 1/08; B67D 1/16; B67D 1/04

(52) U.S. Cl. CPC B67D 1/0857; B67D 1/0412; B67D 1/0891; B67D 1/16

(57) ABSTRACT

A beverage cooler system includes a wheeled cabinet having coiled tubing embedded within a thermally conductive medium such as cast aluminum, the tubing connected by one end to a spout for dispensing the beverage into containers such as mugs or cups. The opposite end of the tubing is connected by hoses to a beverage source, such as a beer keg, stowed within the cabinet along with a cylinder of pressurized gas for impelling the beverage through the tubing. Means are included within the cabinet for storing the spout tower. A drink rail at least partially surrounds a platform surface adjacent the spout tower, the platform also including a drain for spillage connected to an internal waste container. The cabinet skin may be employed to display advertising or decorative images. A table top version includes the beverage cooling chamber but no wheels nor storage chamber.

### BACKGROUND OF THE INVENTION

1. Field of the Invention

This invention relates generally to liquid cooling systems and particularly to systems for cooling potable beverages. More particularly, this invention relates to a beverage cooler which chills small amounts of a beverage while it flows through a cooling block, requiring no refrigeration equipment nor electricity.

2. Description of Related Art

Traditional beverage coolers, most commonly used for chilling draught beer from kegs, include three elements: (a) a container large enough for embedding the keg in ice for cooling all of the beer contained within the keg; (b) a valve for dispensing the beer from the keg, with concomitant connective tubing, usually plastic; and (c) means for impelling the beer from the keg toward the valve.

One common configuration includes a mast that couples directly to the keg at a port designed for the purpose, the mast including a manual pump which may be operated occasionally to pump air into the keg to raise its internal pressure so that beer will be forced out through the port and into a length of flexible hose connected thereto. A thumb valve on the end of the hose dispenses the beer.

Another configuration common in commercial settings includes a refrigerated cabinet to contain the keg, an electric pump for pressurizing the keg and hoses, usually with an inert gas such as nitrogen, and a pub-style lever handle mounted on a mast disposed at a convenient location for dispensing the beer into drinking containers. In a pub setting, the mast commonly is mounted to a counter top or bar, perhaps to a station which includes a drain for collecting spilled beer. In other settings, the mast may be mounted to a cabinet that contains a refrigerated chamber enclosing the keg, and another chamber for the pump and electrically powered chilling equipment. The cabinet may or may not include wheels for adjusting the location of the cabinet.

The manual system described above provides the advantage of not requiring electricity, but it is unsightly, messy, heavy and cumbersome to handle, particularly when assembled. It also requires frequent and periodic manual pumping to keep the beer flowing and a large quantity of ice, which may have to be replenished periodically, to chill the entire keg at once. The commercial system described above overcomes some of the impediments of the manual system, but it is comparatively expensive and requires a source of electricity for the pump and chilling equipment. Both systems also require chilling the entire keg at once, a practice that can be detrimental to the beer contained inside if it is allowed to warm up again before the keg is emptied. A need exists for a system and method for chilling small quantities of beer from a keg without creating a long-term detrimental effect on the unused beer.

A plurality of prior art devices attempt to address with varying successes, none complete, the foregoing disabilities of the conventional prior art. U.S. Pat. No. 7,363,962, issued Apr. 29, 2008, to Cleland (Cleland '962), describes a cold plate for dispensing beer and having a series of beverage conducting tubes interleaved with coolant conducting tubes, both being encased within a cast aluminum jacket. Cleland '962 includes multiple tubing coils instead of a single coil, and obviously requires a separate chilling source to chill and circulate glycol within the coolant conducting tubes. Cleland '962 essentially comprises a traditional heat exchanger mechanism which is overly complex for the purposes of the present invention.

U.S. Pat. No. 6,098,418, issued Aug. 8, 2000, to Kyees (Kyees '418), presents an apparatus for cooling fluids having at least two coiled fluid lines embedded within a cast aluminum block. Each pair of the coiled fluid lines is juxtaposed and stacked one atop its mate with the inner tube ends of each pair tied together with a manifold disposed near the center of the apparatus. The opposite ends of each of the coil pairs protrudes from the aluminum block and has separate connections. The coils are formed in a concave configuration around a central portion which may serve as a drain for the chamber above the apparatus. The chamber holds a quantity of ice which transfers to the aluminum block by contact and thereby to the fluids in the tubes by conduction. Kyees '418 is intended for the commercial setting described above, wherein carbonated soft drinks having constituent fluids (e.g. carbonated water and syrup) first are cooled and then mixed downstream of the apparatus before dispensing into individual drinking containers. Kyees '418 uses ice, and therefor could be employed without a source of electricity, assuming the presence of a source of force to impel the fluids through the tubes. Kyees '418, however, contemplates multiple coils with multiple outlets, thereby making it too large and unwieldy for purposes of the present invention.

### SUMMARY OF THE INVENTION

A beverage cooler system includes a wheeled cabinet having coiled tubing embedded within a thermally conductive medium such as cast aluminum, the tubing connected by one end to a spout for dispensing the beverage into containers such as mugs or cups. The opposite end of the tubing is connected by hoses to a beverage source, such as a beer keg, stowed within the cabinet along with a cylinder of pressurized gas for impelling the beverage through the tubing. Means are included within the cabinet for storing the spout tower. A drink rail at least partially surrounds a platform surface adjacent the spout tower, the platform also including a drain for spillage connected to an internal waste container. The cabinet skin may be employed to display advertising or decorative images. A table top version includes the beverage cooling chamber but no wheels nor storage chamber.

### BRIEF DESCRIPTION OF THE DRAWINGS

The novel features believed characteristic of the present invention may be set forth in appended claims. The invention itself, as well as a preferred mode of use and further objects and advantages thereof, will best be understood by reference to the following detailed description of at least one particular embodiment when read in conjunction with the accompanying drawings, wherein:

FIGS. 1A-1D show a particular embodiment of the present invention.

FIG. 2 shows in upper, quartering perspective, the embodiment of FIGS. 1A-1D.

FIG. 3 shows in top plan view a cooling block of the present invention.

FIGS. 4A-4B detail in side elevational and top plan views, respectively, tubing coils integral with the cooling block of FIG. 3.

FIG. 5 details in expanded side elevational view the tubing coils of FIGS. 4A-4B.

FIGS. 5A-5B detail an alternate embodiment of the cooling block of FIG. 3 and having two sets of tubing coils instead of just one.

FIGS. 6A-10C detail several alternate embodiments of means for storage of the spigot tower of the present invention when not in use.

FIGS. 11A-11B details alternate embodiments of a drink rail atop the present invention.

FIGS. 12A-12B depict another embodiment of the present invention in the form of a table top version of the beverage cooler.

### DESCRIPTION OF A PREFERRED EMBODIMENT

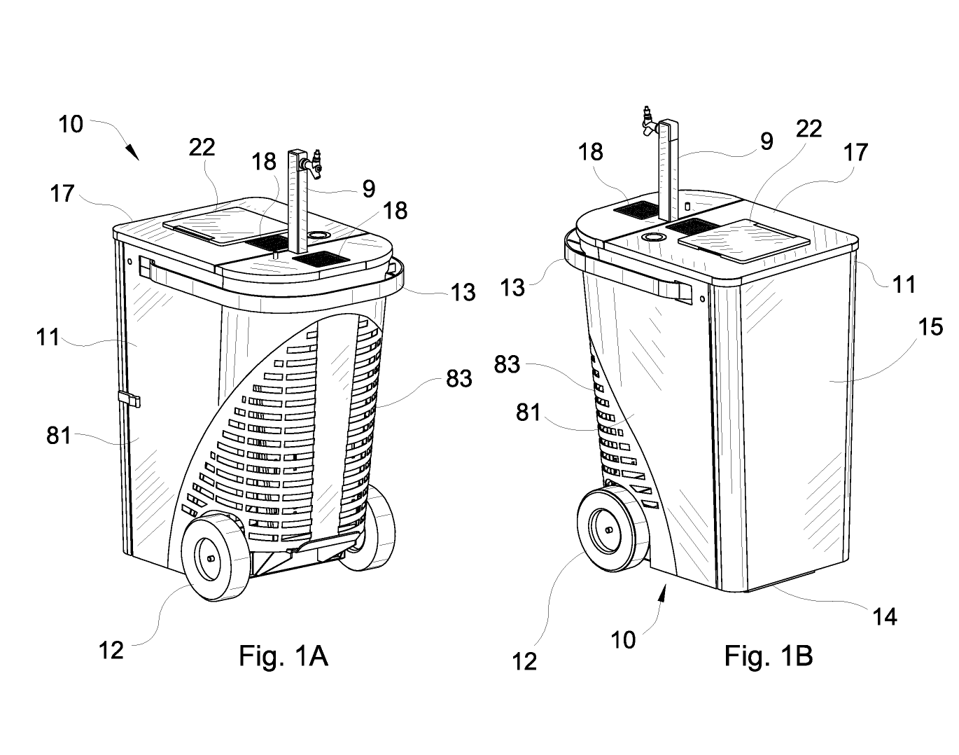

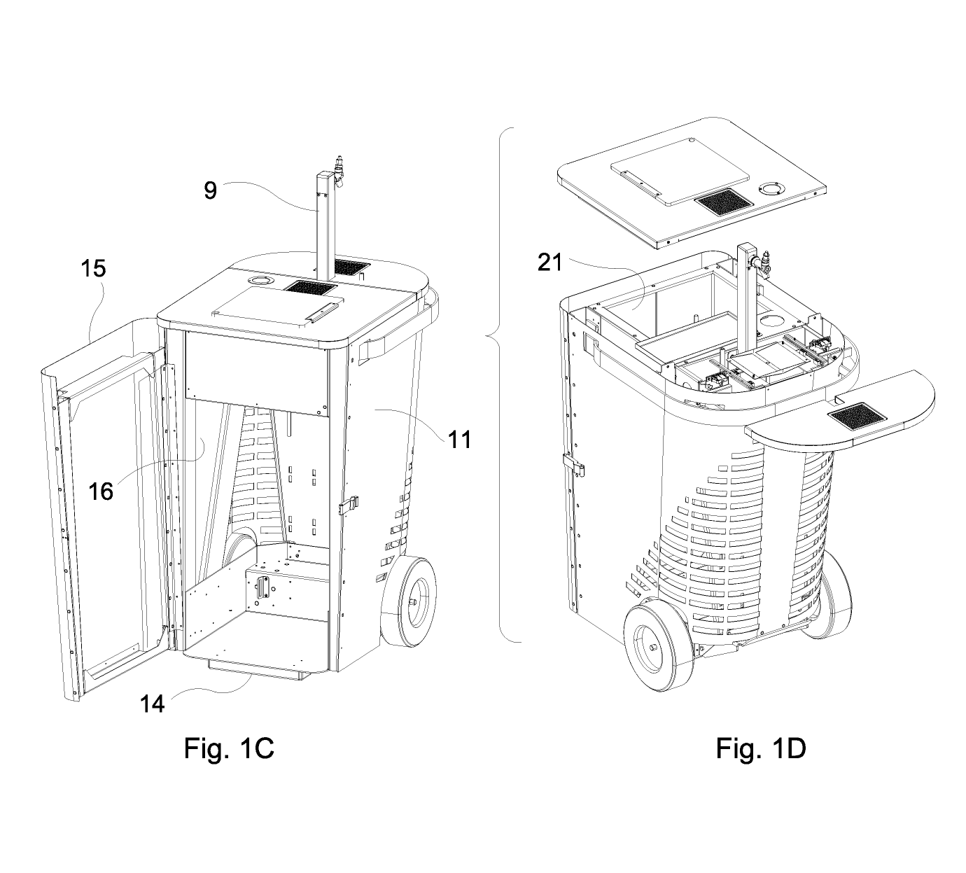

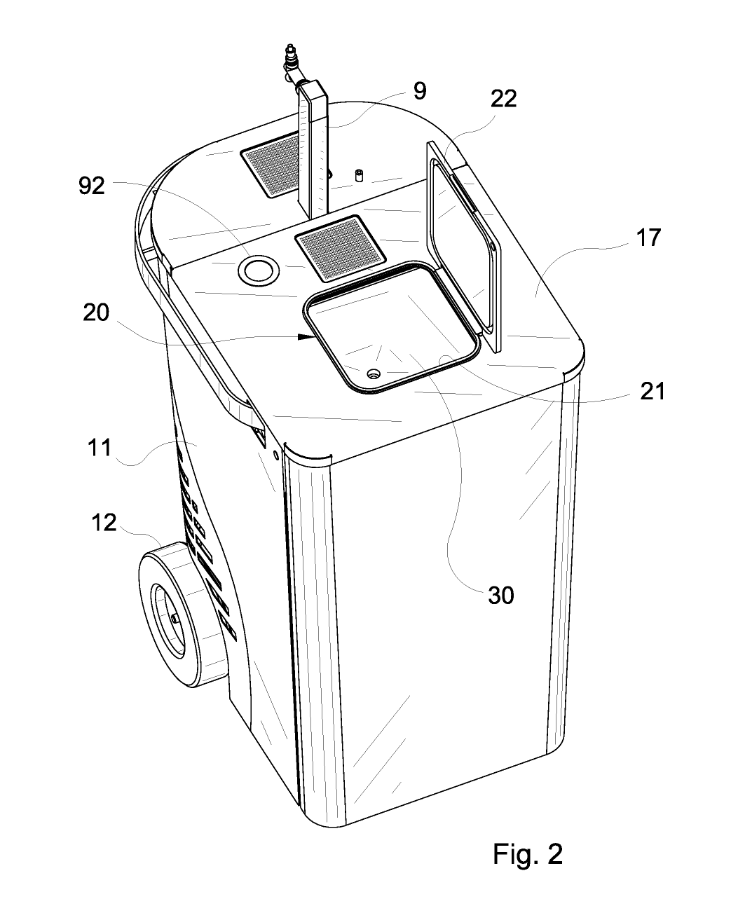

Referring now to the figures, and particularly to FIGS. 1A-1D and 2, cooler 10 includes cabinet 11 supported by wheels 12 and prop 14. Atop cabinet 11, platform 17 supports one or more spillage drains 18 which collect beer spilled during dispensing into a waste receptacle preferably stowed within the lower portion of cabinet 11. At least a portion of platform 17 hingedly couples to cabinet 11 and serves as an access door 22 which opens to reveal ice chamber 20 adapted to contain a quantity of ice, dry ice or synthetic chilling blocks (none shown). In the particular embodiment of the referenced figures, access door 22 doubles as a cutting board for a user (not shown) to chop condiments or the like as desired. Where access door 22 is large enough to require it, a prop (not shown) may supports door 22 above chamber 20.

Cabinet 11 preferably is fabricated from stainless steel beam elements extending between platform 17 and a floor to which wheels 12 and prop 14 couple. The remainder of cabinet 11 may be fabricated from materials of lesser expense, such as plastic or the like to finish cooler 10.

The skin surrounding cabinet 11 provides surfaces which may be employed by commercial or private interests to convey messages. For example, a beer supplier might emboss or paint its logo or some beer enjoyment scene (not shown) onto solid portion 81 of cabinet 11. Additionally, perforated region 83, so included for the functional purpose of, among other things, ventilation and deterrence of growth of mildew and the like within cabinet 11, also may be configured to convey a message, logo or decoration (not shown) by employing variations in the perforations themselves. One having ordinary skill in the art will recognize that other means of providing aesthetically pleasing or commercially promotional messages or decorations on the skin of cabinet 11 may be employed without departing from the spirit and scope of the present invention. Further, though illustrated with specific curvatures and skin coverage, solid areas 81 and perforated areas 83 may vary significantly without departing from the spirit and scope of the present invention.

Door 15 opens to reveal interior chamber 16 wherein is stored keg 1 and gas cylinder 22, as well as other accouterments (not shown) used with cooler 10. Spigot 7, operated by lever 8, is mounted on spigot tower 9 and couples to port 3 atop keg 1 by hoses (not shown) which convey beer from keg 1 to be dispensed by spigot 7 into drinking vessels such as mugs or cups (neither shown). A second set of hoses (not shown) couple gas cylinder 2 to the interior of keg 1 to pressurize keg 1 and force beer into the hoses toward spigot 7.

Unlike with prior art devices, keg 1 is not chilled, but kept within cabinet 11 at ambient temperature. Instead, cooler 10 chills a quantity of beer by means of cooling coils described in detail below. Thus, unused beer remaining within keg 1 remains at a stable, substantially ambient temperature until it is dispensed. This prevents the beer from deteriorating from changes in temperature as with other prior art devices.

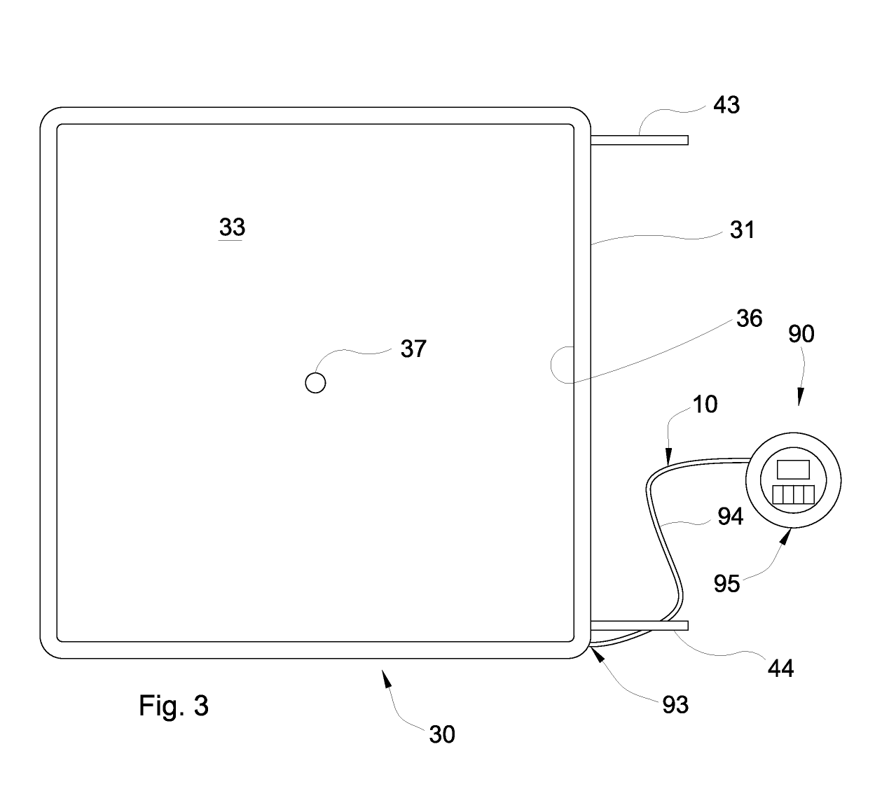

Turning now also to FIGS. 3-5C, the present invention further comprises cooling blocks 30, 300 disposed immediately below ice chamber 20 within cabinet 11. Blocks 30, 300 respectively contain one and two sets of cooling tubing, as discussed in more detail below. One having ordinary skill in the art will recognize that cooling blocks 30, 300 preferably are interchangeable and may be used with either or both of the particular embodiments for a beverage dispenser discussed herein.

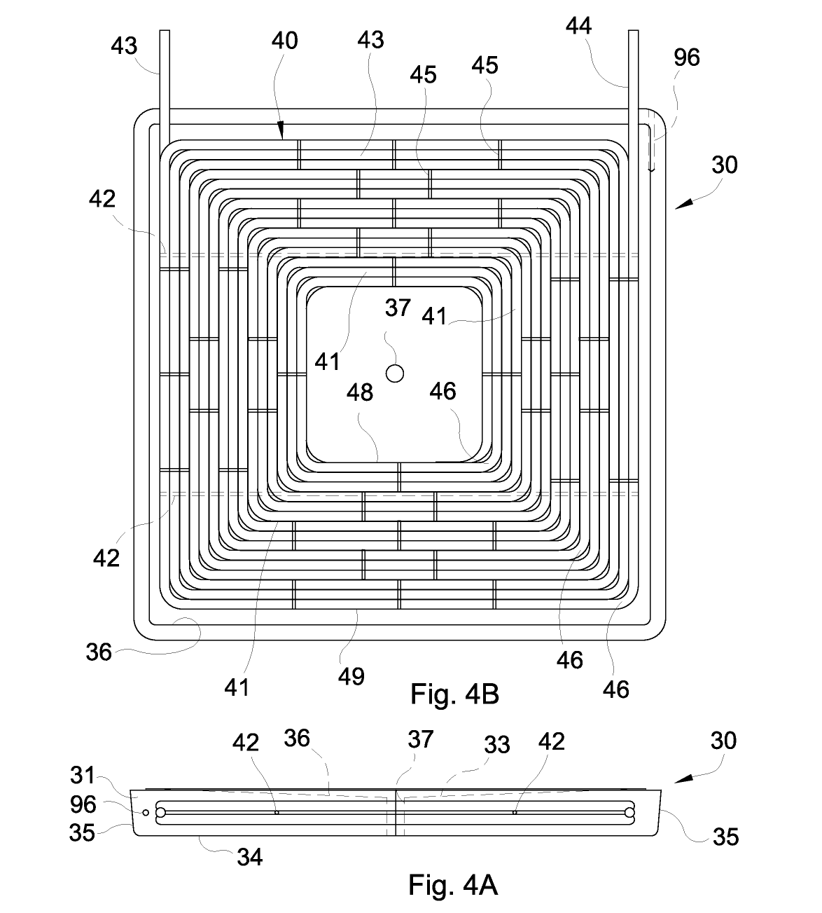

Referring now to FIGS. 3-5A for cooling block 30 having a singe set of cooling coils, upper surface 33 of cooling block 30 forms the floor of ice chamber 20. Ice (not shown) rests directly upon surface 33 to maximize conductive effects between the ice and cooling block 30. As best seen in FIG. 4A, cooling block 30 comprises a comparatively shallow but wide, preferably rectangular and more preferably substantially square block having a slightly concave upper surface 33 forming recess 36 that slopes gently from its perimeter adjacent side walls 35 to central drain 37. Drain 37 comprises a vertical aperture extending through the entire thickness of cooling block 30 to its lower surface 34 where it couples to a drain hose (not shown) which conducts melted ice and condensation from within ice chamber 20 to a waste receptacle (not shown).

Embedded within cooling block 30, coil 40 comprises two layers of metallic tubing 41 bent in a series of substantially right angle curves 46 to form substantially rectangular coils 40 coaxial and concentric around a central open region coaxial with drain 37. Adjacent concentric loops of tubing 41 are tied together at spaced intervals with ties 45 to stabilize their geometry and juxtaposition, and the two layers of coils 40 are held in spaced juxtaposition by transverse coil spacers 42. Except for protruding input and exit ends 43, 44, the entire coil system 40 is embedded in aluminum poured molten into a mold (not shown) to surround and become thermally integrated with coils 40 and to form coil block 30 as a single unit. Temperature sensor 90 comprises probe 93 received within probe port 96 of cooling block 30. Probe 93 couples between coil block 30 and display 95 by cord 94, display 95 being conveniently disposed above platform 17 in one of several alternative locations (see FIGS. 13A-13D).

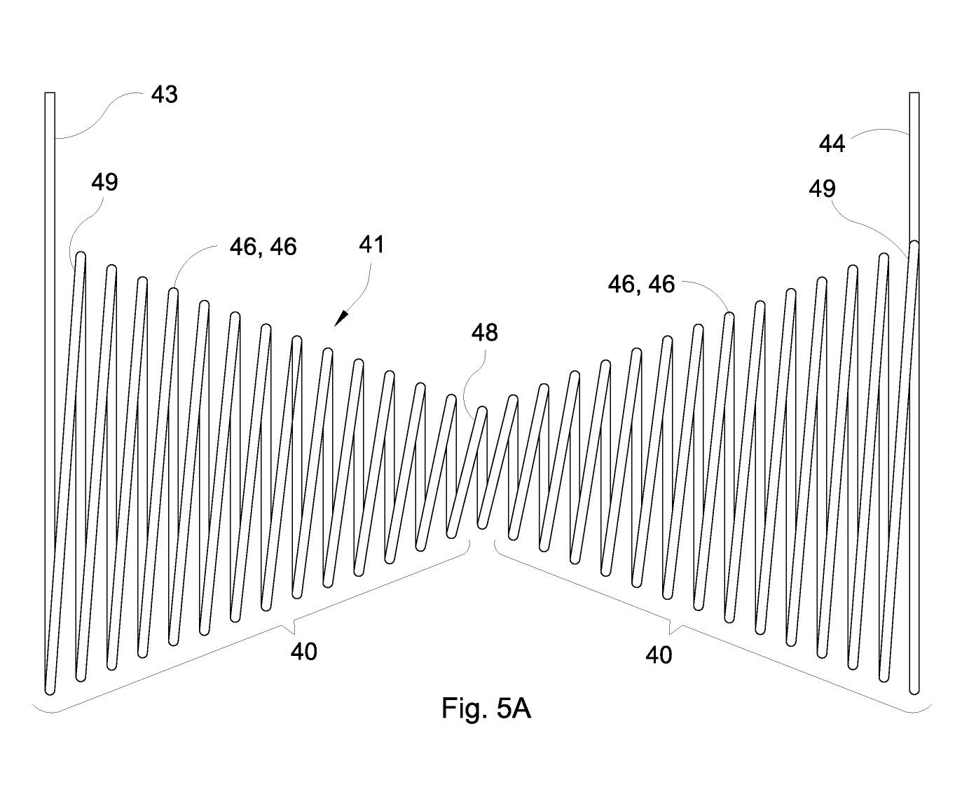

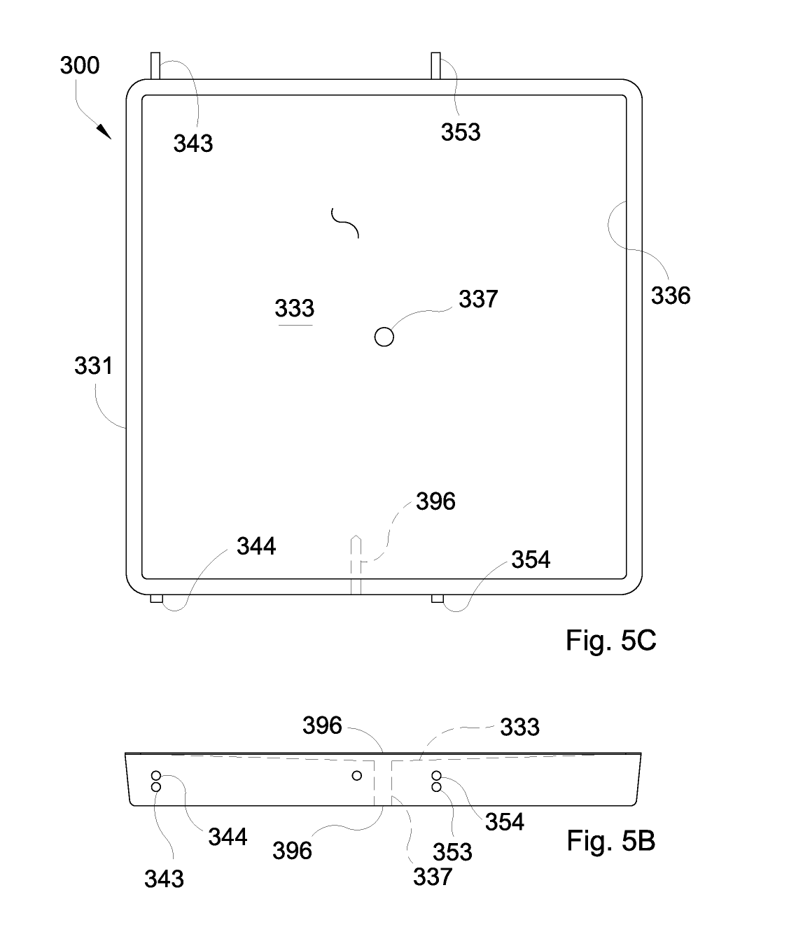

As best illustrated by FIG. 5 (dimentionally exaggerated for illustration along the longitudinal axis of coils 40, coaxial with drain 37), coils 40 are formed from a continuous length of metallic tubing 41 without requiring any manifolds or solder joints between input end 43 and output end 44. Tubing ends 43, 44 extend from the largest single loops 49 of coils 40, which spiral inwardly by means of successively shorter loops that nest tightly against adjacent loops until they reach inner loop 48, whereupon the loops begin to increase again in size until second coil 40 is formed. The two coils stack one atop the other and are connected together by inner loop 48, as best seen in FIG. 4A.

The dimensions of tubing 41 are selected with the benefit of testing and experience to achieve ideal chilling of beer as it passes from keg 1 toward spigot 7, thereby chilling a given quantity of beer to a desired temperature (preferably approximately fifty-five (55 deg. F.) degrees Fahrenheit within a select period of time. Preferably, as beer is drawn from keg 1 under sufficient pressure from gas cylinder 3 to fill a twelve (12 oz.) ounce cup (not shown) in approximately five seconds, it is chilled within coil block 30 rapidly enough that a continuous progression of cups may be filled in ten- to fifteen-second intervals without interruption until keg 1 becomes empty.

In a particular embodiment which meets the above criteria, tubing 41 preferably comprises copper or aluminum tubing either (a) five-sixteenths ( 5/16″) inch diameter and having a length of eighty-nine (89 ft.) linear feet; or (b) three-eighths (⅜″) inch diameter and having a length of approximately eighty-seven (87 ft.) linear feet prior to being formed into coils 40. The thickness of cooling block 30 (i.e. the separation between upper and lower surfaces 33, 34), or alternately the thickness of aluminum surrounding coils 40 may vary according to the above selection criteria, while the outside horizontal dimensions of cooling block 30 will remain substantially the same so as to fit within cabinet 11 and to form the bottom of ice chamber 20. One having ordinary skill in the art will recognize that the above dimensions comprise one of an infinite array of possible lengths and diameters of tubing 41 that will achieve the stated criteria, and that all such variations in materials and dimensions are considered to be within the spirit and scope of the present invention.

Regarding alternate cooling block 300 having two sets of cooling coils 340, 350, all of the foregoing discussion of cooling block 30 applies equally to cooling block 300 except as modified herein after. Referring specifically to FIGS. 5B, 5C, and as best seen in FIG. 5B, cooling coils 340, 350 preferably occupy separate left and right halves of cooling block 300. This provides substantially equal chilling effect to both coils 340, 350 due to their proximity to the ice (not shown) resting on top surface 333 of cooling block 300. Presumably, and preferably, the ice is substantially evenly distributed across surface 333, but one having ordinary skill in the art will recognize that even if this isn't the case, the thermal conductivity of cooling block 300 will disperse disparate quantities of heat from coils 340, 350 through cooling block 300, thereby mitigating or eliminating altogether any differential in chilling effectiveness between coils 340, 350 due to uneven distribution of ice on surface 333.

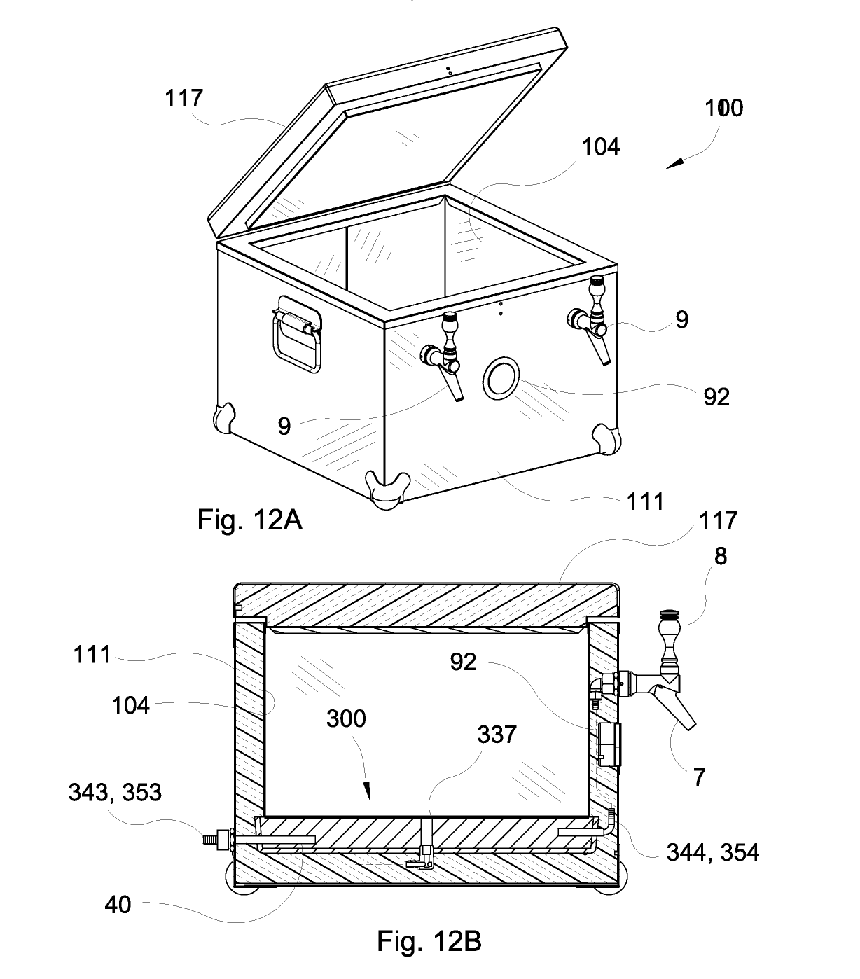

Inlet tube end 343 couples to one beverage supply, such as beer keg 1, while inlet tube end 353 couples to a different beverage supply (not shown). Outlet tube ends 344, 354 couple to separate spigot means 9 preferably mounted to cabinet 11 or cabinet 111 (see FIGS. 12A, 12B) whereby a user (not shown) can access one or both sources of chilled beverages.

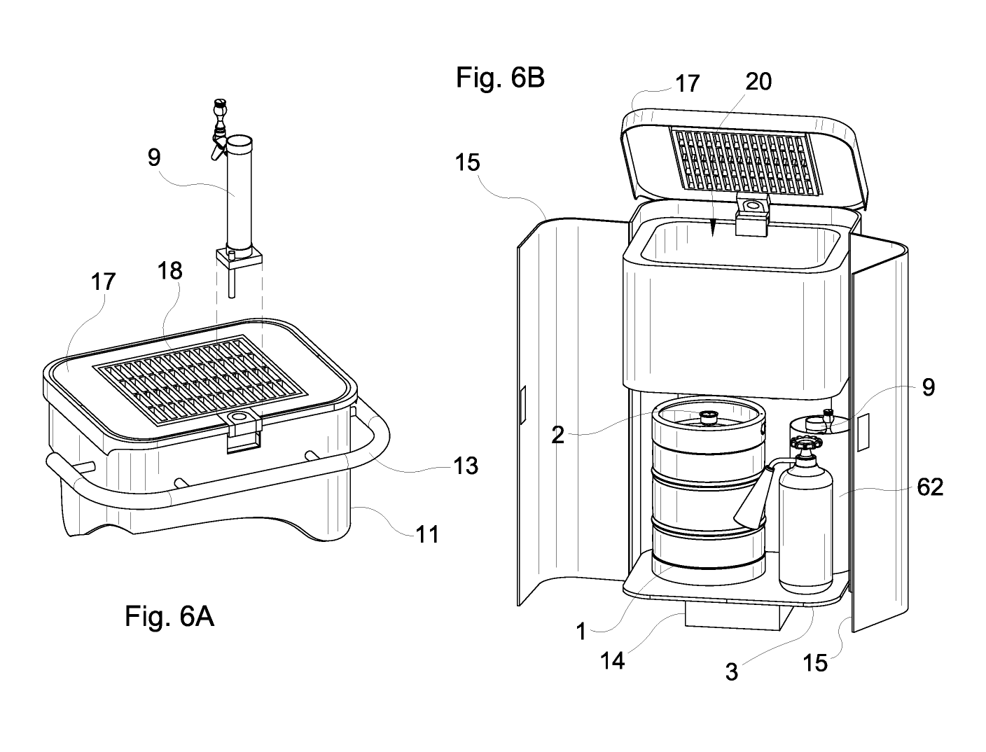

Turning now also to FIGS. 6A-10C, various methods and means are illustrated for storing tower 9, including spigot 7 and lever 8, for transportation and storage when cooler 10 is not in use. Storing tower 9 away from its usage position atop platform 17 protects tower 9 and permits stacking of multiple coolers 10 for inventory and transportation, a significant commercial advantage.

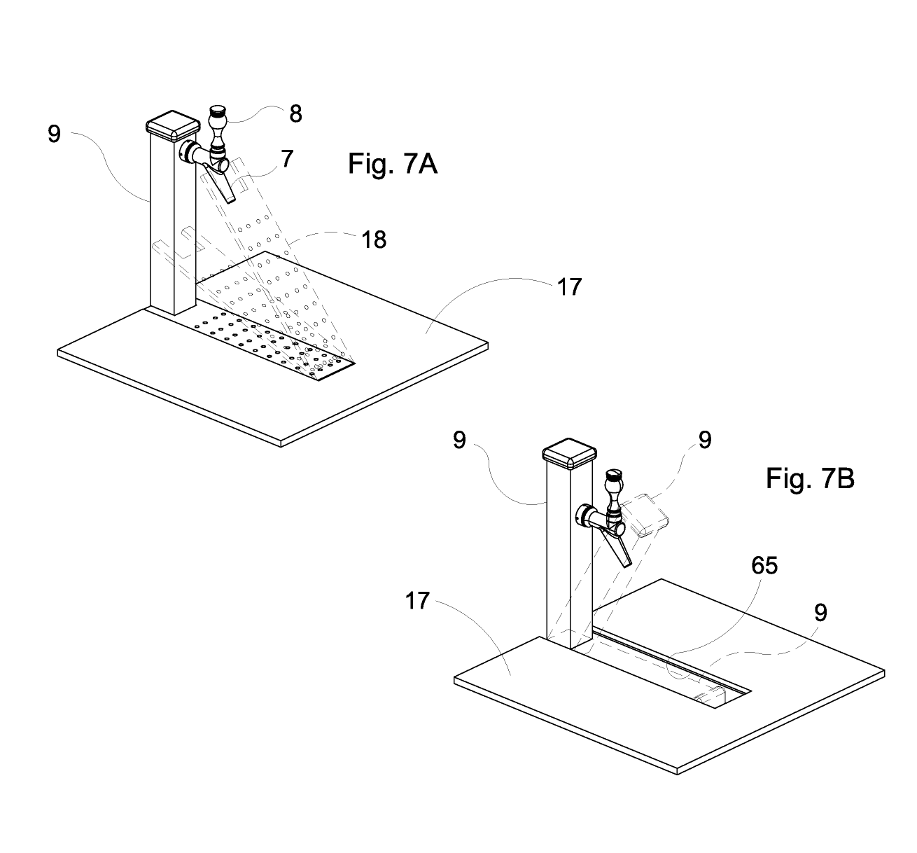

As illustrated in FIGS. 6A-6B, tower 9 may be removed and stored in basket 62 within chamber 16 of cabinet 11 by removing hoses (not shown) connecting it to keg 1 and then releasing a pin holding tower 9 to platform 17. As seen in FIGS. 7A-7B, tower storage recess 65 may be disposed within platform 17 beneath drain 18, the latter lifting up to expose recess 65 and tower 9 hingedly pivoting at its base to fold down into recess 65 to be covered again by drain 18. In this case, as with other alternate embodiments discussed below, there is no need to remove the hoses connecting tower 9 to keg 1, and, after flushing and cleaning in place, they may remain in place for the next usage of cooler 10.

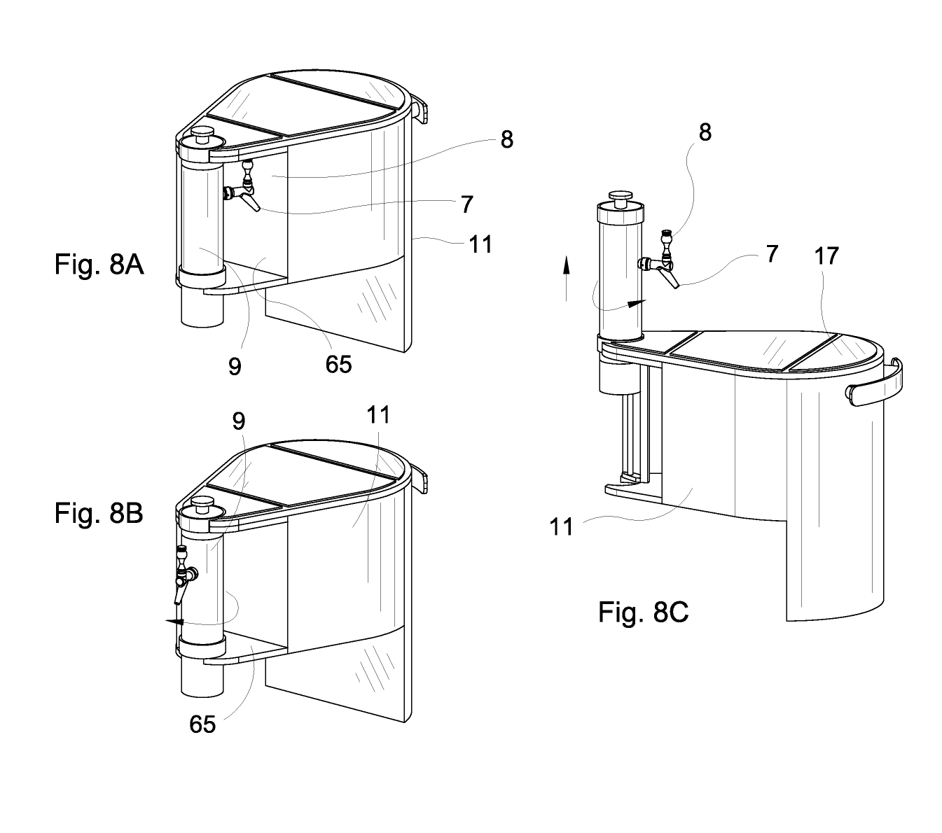

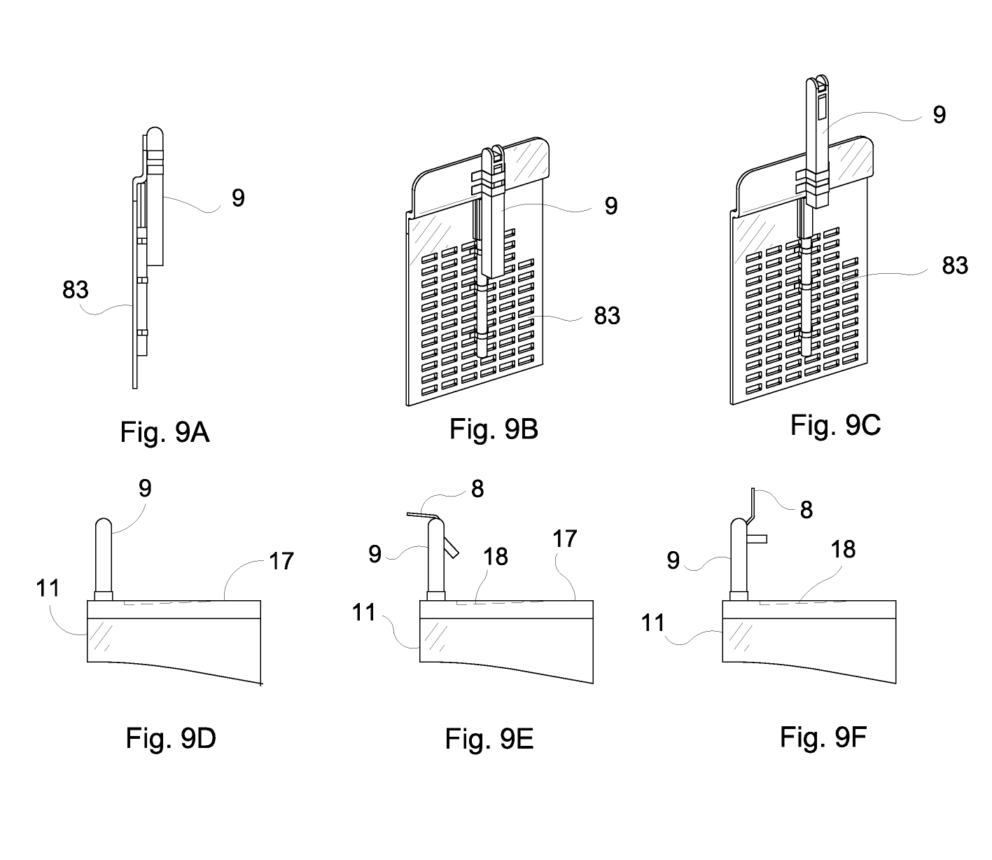

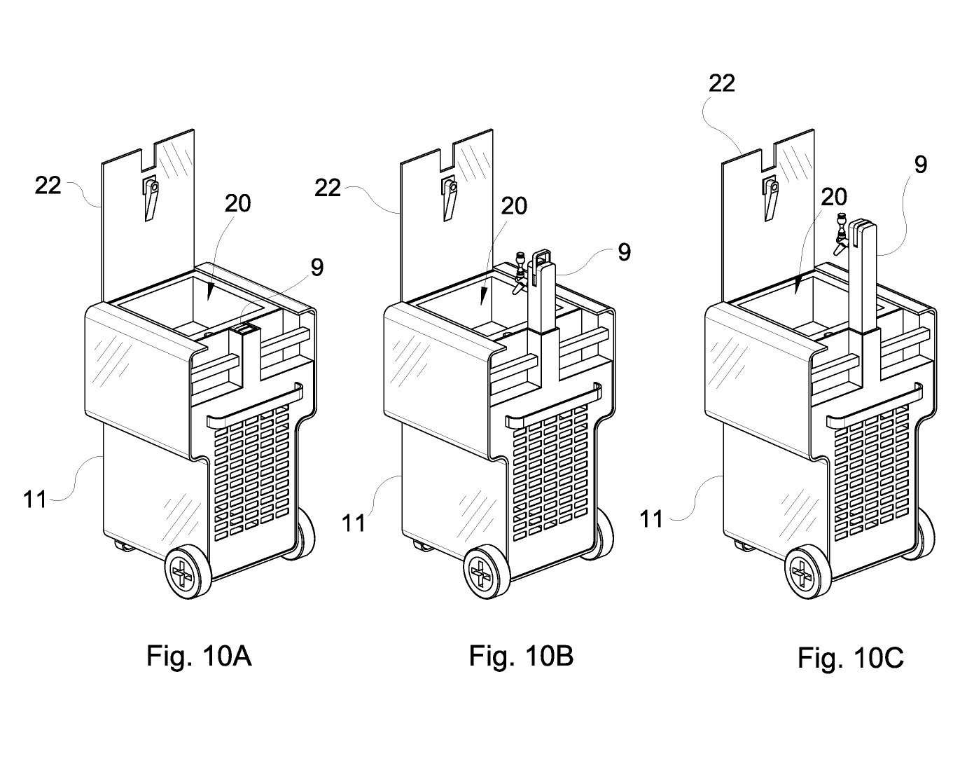

FIGS. 8A-10C illustrate apparatus whereby tower 9 also need not pivot into horizontally disposed recess 65 as shown in FIGS. 7A, 7B, but instead articulate vertically from within vertically disposed recess 65 from a stored position to a usage position. In FIGS. 8A-8C, tower 9 rotates, bayonet style, to be locked first in a stored position, with spigot 7 and lever 8 protected within recess 65, then unlocked by rotation into a vertical extension position and lifted into a usage position, whereupon it rotates into a locked usage position, with spigot 7 facing platform 17. In FIGS. 9A-9F, pressure from gas cylinder 3 automatically lifts tower 9 into a usage position when the control valve (not shown) for gas cylinder 3 is opened. In this embodiment, spigot 7 and lever 8 are retracted into tower 9, and spigot 7 is extended for usage by manually lifting lever 8, as illustrated in FIGS. 9D-9F. As seen in FIGS. 10A-10C, tower 9 simply retracts into recess 65 beneath access panel 22 and can be manually lifted into a usage position with a handle atop tower 9. One having ordinary skill in the art will recognize that other means of retracting and storing tower 9 may be employed without departing from the spirit and scope of the present invention.

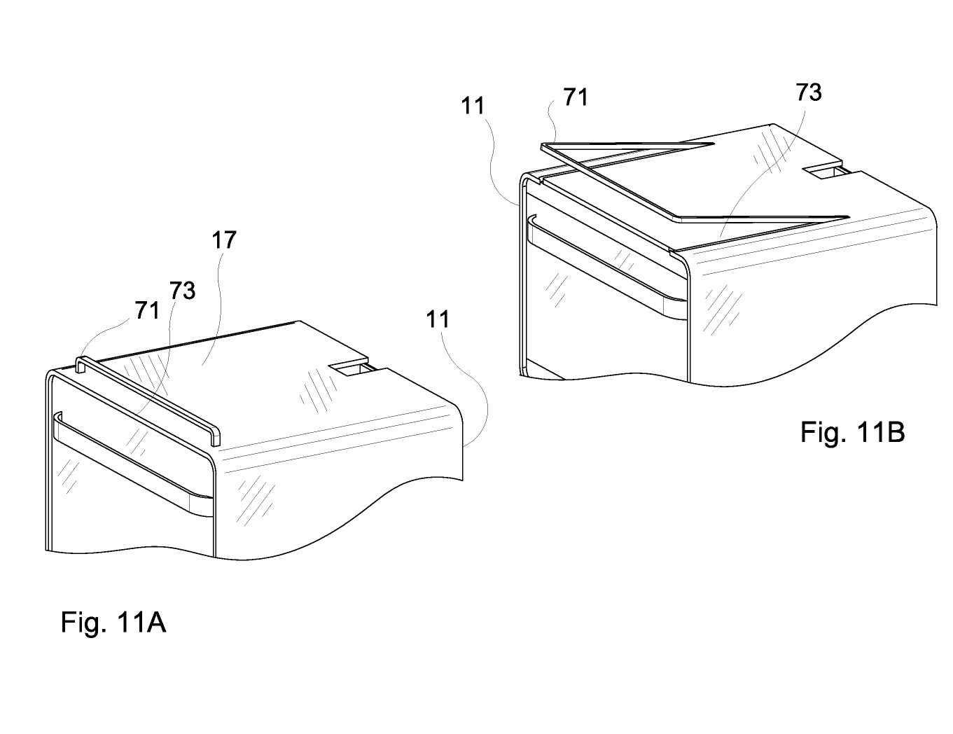

Turning now also to FIGS. 11A-11B, two means for providing drink rail 71 atop platform 17 are displayed, rails 71 deterring drink cups (not shown) from inadvertently being knocked off of cooler 10 while other cups (also not shown) are being filled. In FIG. 11A, substantially horizontal bar 71 is disposed transverse platform 17 opposite tower 9 and retracts into recess 73 disposed parallel to the front face of cabinet 11. In FIG. 11B, rail 71 comprises a rectangularly U-shaped bar that pivots adjacent tower 9 from bar recess 73 to a select height above platform 17, thereby better surrounding platform 17 and accommodating more cups sitting on platform 17 (not shown). One having ordinary skill in the art will recognize that other apparatus and means of providing retractable rails atop platform 17 may be employed without departing from the spirit and scope of the present invention.

Turning now also to FIGS. 12A, 12B a table top version 100 of the present invention includes cabinet 111 surrounding and defining chamber 104. Two spigot means 9 are mounted on one wall, and lit 117 provides access from above into chamber 104. Since two spigot means 9 are provided, presumably cooling block 300 rests in the bottom of interior 104 and forms the bottom thereof. As discussed above, a quantity of ice (not shown) may rest and fill the remaining volume of interior 104. Outlet tube ends 344, 354 are shown stubbed out from cooling coil 300 but remaining within the walls of 111 where they connect to tubing (not shown) that couples them to spigot means 9. Inlet tube ends 343, 353 also stub out from cooling coil 300, but extend beyond the walls of cabinet 111 where they couple to external beverage supplies (not shown) which preferably are stored nearby, such as below a table (not shown) on which table top cooler 100 rests. Drain 337 also stubs out below cooling coil 300 where it couples to an exterior drain line (not shown) and either to a waste receptacle or simply drains onto the ground (neither shown). Handles 116 on opposite sides of cabinet 111 may be provided for lifting and carrying table top cooler 100, and temperature gauge 92 may be provided, coupled to cooling block 300 as discussed above, to give users (not shown) an indication of the termparature of the beverage they're about to dispense.

In operation, a beer supplier may provide cooler 10 as an accommodation to customers in lieu of more conventional apparatus. The beer supplier could install keg 1 ordered by the customer and hook up gas cylinder 3 and the respective hoses necessary to impel beer from keg 1 through cooling block 30 to spigot tower 9. Cooler 10 could be delivered so equipped, because it would not be necessary to chill keg 1 in advance. The user then could be given instructions as to how to extend tower 9, turn on gas cylinder 3, insert ice into ice chamber 20, and pour ideal quantities of beer using spigot 7. The user would not be required to provide so much ice as necessary to chill the entire keg 1, but perhaps could supply enough from a conventional refrigerator ice maker.

Cooler 10 also could be acquired by a user for his personal ownership, and for storage of keg 1 for lengthy periods of time without concern for harming the unused beer inside keg 1. In such case, the user would find a substantially permanent location for cooler 10 and simply re-load it with ice or ice equivalents as needed to chill a cup or two of beer when desired. There would be no need to keep cooler 10 constantly refrigerated, as with conventional home beer chillers of the prior art.

While the invention has been particularly shown and described with reference to preferred and alternate embodiments, it will be understood by those skilled in the art that various changes in form and detail may be made therein without departing from the spirit and scope of the invention. For example, cooling block 30 could be used in other apparatus than just a portable beer dispenser such as cooler 10. Cooling block 30 could be combined with multiple other cooling blocks to achieve the benefits of prior art reference Kyees '418, where different fluids are chilled prior to being mixed downstream of cooling blocks 30 and then fed into a dispenser nozzle such as spigot 7. A single ice chamber 20 could be configured to hold multiple cooling blocks 30 for this purpose. Further, the figures depict cooling block 30 disposed substantially horizontally, with drain 37 provided to siphon off melted ice, but cooling block 30 could be mounted vertically, on one of its side walls 35 and dispense with the need for drain 37 or recess 36.

We claim:

1. A beverage cooler for dispensing small quantities of chilled beverage, said beverage cooler comprising
a cabinet having a cabinet bottom, a cabinet top and cabinet walls surrounding a cabinet interior;
a cooling block disposed within said cabinet interior juxtaposed said cabinet bottom, said cooling block having
at least one length of thermally conductive tubing arrayed in at least one tubing coil disposed above and parallel to said cabinet bottom, said length of tubing having a first tube end and a second tube end, said first and second tube ends protruding from said cooling block;
and
a sheath of thermally conductive medium surrounding said at least one tubing coil, said sheath having a sheath length and a sheath width forming a substantially planar body sized to be coextensive with said cabinet bottom;
an ice chamber disposed above said cooling block within said cabinet interior, said ice chamber adapted to confine a supply of ice in thermal contact with said thermally conductive medium of said cooling block;
drainage means disposed within said cabinet interior and adapted to drain moisture from said ice chamber;
beverage supply means coupled to said first tube end for supplying said beverage to said cooling block; and
dispensing means coupled to said second tube end for dispensing said beverage from said beverage cooler.

2. The beverage cooler of claim 1 wherein
said cabinet interior comprises an upper and a lower chamber, each of said upper and lower chamber having upper and lower chamber bottoms and upper and lower chamber walls;
said cooling block is disposed within said upper chamber juxtaposed said upper chamber bottom; and
said beverage supply means is disposed within said lower chamber.

3. The beverage cooler of claim 2 and further comprising
wheels disposed on opposite sides of said cabinet adjacent said lower chamber bottom;
a handle disposed on said cabinet above said wheels and adjacent said cabinet top;
doors disposed within said cabinet walls and adapted to open to provide access to said lower chamber interior;
an access hatch disposed within said cabinet top and adapted to provide access to said upper chamber;
at least one spill drain disposed within said cabinet top juxtaposed said dispensing means and adapted to collect beverage spilled during said dispensing of said beverage; and
a temperature gauge disposed on said cabinet and coupled to said cooling block.

4. The beverage cooler of claim 1 wherein said beverage supply means comprises
a beverage container having
an interior containing said beverage;
a gas input port coupled to said interior; and
a beverage output port coupled to said interior;
a gas canister pneumatically coupled to said input port;
a pneumatic hose coupled between said beverage output port and said first end.

5. The beverage cooler of claim 1 wherein said dispensing means comprises
a spigot mast mounted to said cabinet
at least one spigot mounted to said spigot mast and coupled to said second tube end; and
at least one spill drain disposed within said cabinet top below said spigot and adapted to collect beverage spilled during dispensing of said beverage from said spigot.

6. The beverage cooler of claim 5 wherein
said spigot mast is adapted to articulate between an upright position for dispensing said beverage and a stowed position within a mast storage cavity within said cabinet top.

7. The beverage cooler of claim 6 wherein
said spigot mast pivots between said upright position and said stowed position.

8. The beverage cooler of claim 1 wherein
said spigot mast has a longitudinal axis disposed substantially normal to said cabinet top;
and
said spigot mast articulates along said longitudinal axis between an extended position disposed substantially above said cabinet top for dispensing said beverage and a stowed position substantially below said cabinet top.

9. The beverage cooler of claim 1 and further comprising
a rail at least partially surrounding said cabinet top and adapted to confine to said cabinet top beverage containers resting on said cabinet top.

10. The beverage cooler of claim 9 wherein
said rail pivots about a transverse axis substantially within a plane of said cabinet top between a deployed position elevated a spaced distance above said cabinet top and a stowed position recessed within said cabinet top.

11. The beverage cooler of claim 1 wherein said at least one length of thermally conductive tubing comprises
a tubing diameter and a tubing length selected to cause twelve ounces of said beverage to be chilled from ambient temperature upon entering said first tubing end to a temperature between fifty degrees Fahrenheit and sixty degrees Fahrenheit upon leaving said second tubing end.

12. The beverage cooler of claim 11 wherein
said beverage is chilled within fifteen seconds.

13. A beer cooler for chilling and dispensing beer, said beer being contained at ambient temperature before being chilled while dispensed, said beer cooler comprising
a cabinet having a cabinet bottom, a cabinet top and cabinet walls surrounding and defining cabinet interior;
a cooling block disposed within said cabinet interior, said cooling block having
thermally conductive tubing arrayed in a planar tubing coil disposed above and parallel to said cabinet bottom, said planar tubing coil having an inlet end and an outlet end; and
thermally conductive medium surrounding said planar tubing coil and forming a shallowly dished surface disposed a spaced distance above said cabinet bottom, said cooling block further surrounding and defining a central drain;
beer supply means coupled to said inlet end for supplying said beer to said cooling block;
and
dispensing means coupled to said outlet end for dispensing said beer from said beer cooler.

14. The beer cooler of claim 13 wherein
said thermally conductive tubing is selected from a group of conductive tubing having
an inside diameter of five sixteenths inch and a length of eighty-nine feet; and
an inside diameter of three eighths inch and a length of eighty-seven feet.

15. An improved method of cooling beverages, the method comprising
providing a beverage cooling chamber having a chamber top, a chamber bottom and chamber walls surrounding and defining a chamber interior;
providing a cooling block disposed within said chamber interior juxtaposed said chamber bottom, said cooling block having
at least one length of thermally conductive tubing arrayed in at least one tubing coil disposed substantially parallel to said chamber bottom, said length of tubing having a first tube end and a second tube end, said first and second tube ends protruding from said cooling block; and
a sheath of thermally conductive medium surrounding said tubing coil, said sheath having a sheath length and a sheath width forming a substantially planar body sized to be coextensive with said chamber bottom;
providing beverage supply means coupled to said first tube end;
providing dispensing means coupled to said second tube end;
providing a supply of ice disposed atop said cooling block within said chamber interior;
then
operating said beverage supply means to introduce a first portion of said beverage into said cooling block;
and
operating said dispensing means to dispense said first portion of said beverage from said cooling block
whereby said first portion of said beverage is chilled by said supply of ice as it passes through said at least one length of conductive tubing within said cooling block, and
whereby a second portion of said beverage remaining within said beverage supply means remains unchilled.
